(19) United States
(12) Patent Application Publication
(10) Pub. No.: US 2025/0280896 A1
(43) Pub. Date: Sep. 11, 2025

(54) AEROSOL-GENERATING DEVICE AND AEROSOL-DELIVERY SYSTEM

(71) Applicant: Philip Morris Products S.A., Neuchatel (CH)

(72) Inventors: Silvia CAPO, Neuchâtel (CH); Yiu Chi CHEUNG, Hong Kong (HK); Stéphane ESSADE, Lausanne (CH); Philip NAYLOR, Lausanne (CH); Hüseyin Efe SENYILMAZ, Hauterive (CH)

(73) Assignee: Philip Morris Products S.A., Neuchatel (CH)

(21) Appl. No.: 18/861,286

(22) PCT Filed: Jun. 29, 2023
(86) PCT No.: PCT/EP2023/067833

§ 371 Date: Oct. 29, 2024

(30) Foreign Application Priority Data
Jul. 20, 2022 (EP) 22186065.3

(51) Int. Cl. A24F 40/60; A24F 40/20; A24F 40/465; A24F 40/57; H05B 6/10

(52) U.S. Cl. CPC A24F 40/60; A24F 40/465; A24F 40/57; H05B 6/108; A24F 40/20

(57) ABSTRACT

An aerosol-generating device for heating an aerosol-forming substrate to generate an inhalable aerosol during a usage session is provided, the aerosol-generating device including: control electronics; and an annular outer lighting area surrounding an inner lighting area, the control electronics being coupled to the annular outer lighting area and the inner lighting area and configured to i) selectively illuminate one of the annular outer lighting area and the inner lighting area to generate a first predetermined light emission conveying first data indicative of a state of the aerosol-generating device, and ii) selectively illuminate the other of the annular outer lighting area and the inner lighting area to generate a second predetermined light emission conveying second data indicative of a state of the aerosol-generating device, the first data and the second data being different from one another.

The present disclosure relates to an aerosol-generating device in which data concerning a state of the device is visually conveyed to a user of the device. The present disclosure also relates to an aerosol-delivery system including such an aerosol-generating device.

Aerosol-generating devices configured to generate an aerosol from an aerosol-forming substrate, such as a tobacco containing substrate, are known in the art. Typically, an inhalable aerosol is generated by the transfer of heat from a heat source to a physically separate aerosol-forming substrate or material, which may be located within, around or downstream of the heat source. An aerosol-forming substrate may be a liquid substrate contained in a reservoir. An aerosol-forming substrate may be a solid substrate. An aerosol-forming substrate may be a component part of a separate aerosol-generating article configured to engage with an aerosol-generating device to form an aerosol. During consumption, volatile compounds are released from the aerosol-forming substrate by heat transfer from the heat source and entrained in air drawn through the aerosol-generating article. As the released compounds cool, they condense to form an aerosol that is inhaled by the consumer.

During use of the aerosol-generating device, changes in one or more parameters of the device may occur. It is desired to provide an aerosol-generating device which is able to efficiently convey data concerning a state of the device to a user.

As used herein, the term “aerosol-generating device” is used to describe a device that interacts with an aerosol-forming substrate of an aerosol-generating article to generate an aerosol. Preferably, the aerosol-generating device is a smoking device that interacts with an aerosol-forming substrate of an aerosol-generating article to generate an aerosol that is directly inhalable into a user's lungs thorough the user's mouth. The aerosol-generating device may be or include a holder for a smoking article. Preferably, the aerosol-generating article is a smoking article that generates an aerosol that is directly inhalable into a user's lungs through the user's mouth. More preferably, the aerosol-generating article is a smoking article that generates a nicotine-containing aerosol that is directly inhalable into a user's lungs through the user's mouth.

As used herein, the term “aerosol-forming substrate” denotes a substrate consisting of or comprising an aerosol-forming material that is capable of releasing volatile compounds upon heating to generate an aerosol.

According to one aspect of the present disclosure, there is provided an aerosol-generating device for heating an aerosol-forming substrate to generate an inhalable aerosol during a usage session. The aerosol-generating device comprises control electronics. The aerosol-generating device may comprise at least one of an annular outer lighting area and an inner lighting area. The annular outer lighting area may surround the inner lighting area. The control electronics may be coupled to at least one of the outer and inner lighting areas. The control electronics may be configured to: i) selectively illuminate the outer lighting area or the inner lighting area to generate a first predetermined light emission conveying first data indicative of a state of the aerosol-generating device; and/or ii) selectively illuminate the outer lighting area or the inner lighting area to generate a second predetermined light emission conveying second data indicative of a state of the aerosol-generating device. The first data and the second data may be different from one another.

As used herein, the term “light” refers to emissions of electromagnetic radiation which are in the visible range of the electromagnetic spectrum. The visible range of the electromagnetic spectrum is generally understood to encompass wavelengths in a range of about 380 nanometres to about 750 nanometres.

As used herein, the term “predetermined light emission” is an emission of light characterised in terms of one or more parameters of the light emission. By way of example, the one or more parameters may include any of: a luminance level of the light emission, a spatial variation in luminance level of the light emission over one or both of the outer and inner lighting areas, a colour of the light emission, a spatial variation in colour of the light emission over one or both of the outer and inner lighting areas, a proportion of one or both of the outer and inner lighting areas which is activated to generate the light emission. The one or more parameters may also include a variation with time of any of the parameters described in the previous sentence.

The usage session is a finite usage session; that is a usage session having a start and an end. The usage session may have a fixed duration. The duration of the usage session as measured by time may be influenced by use during the usage session. The duration of the usage session may have a maximum duration determined by a maximum time from the start of the usage session. The duration of the usage session may be less than the maximum time if one or more monitored parameters reaches a predetermined threshold before the maximum time from the start of the usage session. By way of example, the one or more monitored parameters may comprise one or more of: i) a cumulative puff count of a series of puffs drawn by a user since the start of the usage session, ii) a cumulative volume of aerosol evolved from the aerosol-forming substrate since the start of the usage session, and iii) a total heating time.

The coupling of the control electronics to the outer and inner lighting areas as described above allows each lighting area to provide a user with data in a visual format indicative of a state of the device. The use of outer and inner lighting areas facilitates each lighting area separately conveying different data to a user.

The outer lighting area and the inner lighting area may collectively form a common lighting array.

The common lighting array may comprise a plurality of lighting elements. Further, the control electronics may be configured to: control a first subset of the plurality of lighting elements of the common lighting array to generate the first light emission; and control a second subset of the plurality of lighting elements of the common lighting array to generate the second light emission. Preferably, the first and second subsets are distinct from each other, meaning that none of the plurality of lighting elements are common to both the first and second subsets.

Conveniently, the inner lighting area may comprise a single lighting element. The single lighting element may be centrally positioned in the inner lighting area.

Alternatively, the inner lighting area may comprise a group of lighting elements. The group of lighting elements may be arranged in a circular pattern about a centre of the inner lighting area.

Preferably, either or both of the outer and inner lighting areas is semi-opaque. By way of example, a display window of either or both of the outer and inner lighting areas may be semi-opaque. Semi-opacity of the inner and outer lighting areas or corresponding display windows may provide the first and/or second predetermined light emissions as diffuse light emissions to a user of the device.

Conveniently, the aerosol-generating device may extend longitudinally between first and second ends. The outer and inner lighting areas may be provided on a lateral surface defining one of the first and second ends.

The aerosol-generating device may comprise a first housing and a second housing. The first housing may be detachably couplable to the second housing.

The first housing may define or comprise a holder for an aerosol-generating article comprising an aerosol-forming substrate. The holder may comprise an inductive heating arrangement. Alternatively, the heater may comprise a resistive heating arrangement.

The second housing may extend longitudinally between first and second ends. The outer and inner lighting areas may be provided on a lateral surface defining one of the first and second ends.

The second housing may comprise one or more of: a power source, control circuitry for controlling a heating arrangement, and one or more buttons accessible from outside of the second housing.

Where the second housing comprises one or more buttons accessible from outside of the second housing, at least one of the one or more buttons may be operable to select, activate, change, pause or deactivate an operating mode of the aerosol-generating device. The button may also be coupled to the control electronics such that the first or second predetermined light emission is indicative of the operating mode that is selected, activated, changed, paused or deactivated by operation of the button. The operating mode may comprise one or more of a pre-heating mode and a pause mode. The one or more buttons may consist of a first button and a second button. It will be appreciated that the one or more buttons may comprise more than two buttons.

Preferably, at least one of the first and second data may be indicative of any one of: a) the aerosol-generating device having been activated by a user; b) selection, activation, changing, pausing, deactivating or progression of an operating mode of the aerosol-generating device; c) an energy level of a power source of the aerosol-generating device; d) a power source of the aerosol-generating device containing sufficient energy to complete a single usage session; e) a power source of the aerosol-generating device containing sufficient energy to complete two or more usage sessions; f) a power source of the aerosol-generating device containing a level of energy below a predetermined threshold level of energy; g) selection or activation of one of a first predetermined thermal profile and a second predetermined thermal profile, in which each of the first and second predetermined thermal profiles define a heating profile for heating of the aerosol-forming substrate by an electrical heating arrangement over the usage session, the first and second predetermined thermal profiles being different to each other; h) the aerosol-generating device being in one of a pause mode state or a reactivation state; i) selection or activation of a change in operational state of the aerosol-generating device; j) progression through the usage session; and k) progression through a pre-heating phase in which an electrical heating arrangement is heated to a predetermined target temperature. In this manner, one or both of the outer and inner lighting areas facilitate conveying to a user data in a visual format relating to a given state of the device.

Preferably, the first data may relate to a state of progression of an operational phase of the aerosol-generating device. The second data may relate to a different state of the aerosol-generating device. The first predetermined light emission may be a predetermined phase progression light emission. The second predetermined light emission may be a predetermined state light emission. The control electronics may be configured to: i) selectively activate one of the outer and inner lighting areas to generate the predetermined phase progression light emission indicative of and in response to progression of the operational phase of the aerosol-generating device; and ii) selectively activate the other of the outer and inner lighting areas to generate the predetermined state light emission indicative of and in response to the different state of the aerosol-generating device. By way of example, the operational phase may be a pre-heating phase in which an electrical heating arrangement for heating of the aerosol-forming substrate is heated to a predetermined target temperature; alternatively, the operational phase may be the usage session.

With progression through the operational phase, the control electronics may increase or decrease any one or more of: a luminance of the lighting area generating the predetermined phase progression light emission, and a proportion of the lighting area which is activated to generate the predetermined phase progression light emission.

Preferably, the control electronics may be configured to: i) selectively activate the outer lighting area to generate the predetermined phase progression light emission; and ii) selectively activate the inner lighting area to generate the predetermined state light emission. As the outer lighting area surrounds the inner lighting area, the geometry of the outer lighting area makes it particularly suitable for conveying data to a user indicative of progression through an operational phase of the aerosol-generating device, in the form of the predetermined phase progression light emission.

The control electronics may be configured to generate the predetermined phase progression light emission and the predetermined state light emission simultaneously.

Preferably, the control electronics are configured to progressively reduce or progressively increase an activated area of one of the outer lighting area and the inner lighting area with progression through the operational phase of the aerosol-generating device to generate the predetermined phase progression light emission. By “activated area” is meant a portion of the lighting area from which the predetermined phase progression light emission is emitted. In this manner, a decreasing or increasing proportion of one of the outer and inner lighting areas contributes to the generation of the predetermined phase progression light emission with progression through the operational phase. In this context, the predetermined phase progression light emission resembles a timer counting downwards or upwards with progression through the operational phase.

As indicated in subsequent paragraphs, the lighting areas may each include a plurality of light emitting elements. Variation in the activated area or the activated length may be achieved by varying the number of the plurality of light emitting elements in the respective lighting area which are activated with progression through the operational phase.

The control electronics may be configured to vary an activated thickness of the annular outer lighting area with respect to time in generating either of the predetermined phase progression light emission or the predetermined state light emission. In this manner, the thickness of the annular outer lighting area that is illuminated in the generation of the predetermined phase progression light emission or the predetermined state light emission changes with respect to time. This time-dependent variation in the activated thickness may include a progressive increase in the activated thickness followed by a progressive decrease in the activated thickness. The variation in the activated thickness may be cyclical. The annular outer lighting area may include a plurality of light emitting elements extending across the thickness of the annular lighting area, with the variation with respect to time of the activated thickness being achieved by varying the number of the light emitting elements which are activated across the thickness.

At least one of the outer lighting area and the inner lighting area may be formed of distinct first and second portions. The control electronics may be configured to: progressively reduce or progressively increase an activated area of the first portion with progression through a first usage session to generate a predetermined first usage session light emission. The control electronics may also be configured to progressively reduce or progressively increase an activated area of the second portion with progression through a second usage session to generate a predetermined second usage session light emission. In this manner, each of the first and second portions of the respective lighting area is able to provide a user with data in a visual format indicative of progression of a corresponding usage session. The first usage session and second usage session are distinct usage sessions. Preferably, the second usage session is a usage session immediately following the first usage session. Where the aerosol-generating device includes a rechargeable power source, the second usage session may preferably be performed using whatever energy remains in the power source after the first usage session. Preferably, the distinct first and second portions are symmetrically disposed on opposed sides of a bisector of the respective outer and inner lighting area.

The control electronics may be configured to activate a first proportion of one of the outer and inner lighting areas to generate a predetermined first state light emission indicative of and in response to the aerosol-generating device being in a first state. The control electronics may further be configured to activate a second proportion of the respective lighting area to generate a predetermined second state light emission indicative of and in response to the aerosol-generating device being in a second state. The second proportion may be greater in size than the first proportion. In this manner, the proportion of the respective lighting area which is activated is able to provide a user with a visual indication of the aerosol-generating device being in one of two distinct states.

The aerosol-generating device may further comprise a power source coupled to the control electronics. The first state may correspond to the power source containing sufficient energy to complete a single usage session. The second state may correspond to the power source containing sufficient energy to complete two or more usage sessions. In this manner, the predetermined first state light emission would be indicative of the power source containing a level of energy sufficient to complete only a single usage session, whereas the predetermined second state light emission would be indicative of the power source containing a level of energy sufficient to complete two or more usage sessions.

The aerosol-generating device may further comprise a power source coupled to the control electronics. The first state may correspond to activation by the control electronics of a first predetermined thermal profile for heating of the aerosol-forming substrate by an electrical heating arrangement over the usage session. The second state may correspond to activation by the control electronics of a second predetermined thermal profile for heating of the aerosol-forming substrate by the electrical heating arrangement over the usage session. In this manner, the predetermined first state light emission would be indicative of selection of the first predetermined thermal profile for the electrical heating arrangement over the usage session, and the predetermined second state light emission would be indicative of selection of the second predetermined thermal profile for the electrical heating arrangement over the usage session. The first and second predetermined thermal profiles are different to each other. The second predetermined thermal profile may have a greater intensity than the first predetermined thermal profile. For example, the second predetermined thermal profile may be associated with supply of a greater amount of energy from a power source to the electrical heating arrangement over the usage session than for the first predetermined thermal profile.

The power source may be in the form of a battery, preferably a rechargeable battery.

The control electronics may be configured to selectively activate different parts of one of the outer lighting area and the inner lighting area over time such that an activated portion of the respective lighting area travels along the lighting area over time to generate one of the predetermined phase progression light emission and the predetermined state light emission.

Conveniently, the state of the aerosol-generating device to which the predetermined state light emission corresponds may be a reactivation state or a pause mode state. The reactivation state may correspond to the control electronics controlling a supply of energy from a power source to an electrical heating arrangement to heat the aerosol-forming substrate at a first temperature level in an aerosol-releasing mode. The pause mode state may correspond to the control electronics controlling the supply of energy from a power source to the electrical heating arrangement to heat the aerosol-forming substrate at a second temperature level below the first temperature level.

The control electronics may be configured to progressively increase a dominant wavelength of the predetermined phase progression light emission with progression through the operational phase of the aerosol-generating device. In this manner, the colour of the predetermined phase progression light emission is able to be adjusted to reflect progression through the operational phase. Advantageously, the dominant wavelength is in the range 380 to 500 nanometres at a start of the operational phase and is in the range 590 to 700 nanometres at an end of the operational phase. So, with progression through the operational phase, the colour of the predetermined phase progression light emission may be adjusted from a colour at the blue end of the electromagnetic spectrum to a colour at the red end of the electromagnetic spectrum. Where the operational phase is the pre-heating phase, the increase in the dominant wavelength towards the red end of the electromagnetic spectrum over the pre-heating phase would provide a user of the aerosol-generating device with an indication that the electrical heating arrangement is increasing in temperature as intended.

Advantageously, a predetermined area of the inner lighting area defines a predetermined shape. The control electronics may be configured to activate the predetermined area defining the predetermined shape to generate either of the first predetermined light emission or the second predetermined light emission. In this manner, the shape of the first or second predetermined light emission may be used to provide a user with an indication of a state of the aerosol-generating device.

The aerosol-generating device may comprise a touch-activated interface. The touch-activated interface may be coupled to the control electronics and comprise an activation area contactable by a user's digit so as to provide a user input to the control electronics. Preferably, the touch-activated interface may form part of either or both of the outer lighting area and the inner lighting area. The activation area may be defined between the outer lighting area and the inner lighting area. Conveniently, the touch-activated interface may comprise a capacitive panel.

The control electronics may be configured to selectively activate either or both of the outer and inner lighting areas at two or more luminance levels, so as to vary the luminance with respect to time of at least one of the first predetermined light emission and the second predetermined light emission. The change in luminance with respect to time may be particularly beneficial where the predetermined light emission is indicative of progression of an operational phase of the aerosol-generating device.

The control electronics may be configured to selectively activate either or both of the outer and inner lighting areas in two or more colour states, so as to vary the colour with respect to time of at least one of the first predetermined light emission and the second predetermined light emission. The change in colour with respect to time may be particularly beneficial where the predetermined light emission is indicative of progression of an operational phase of the aerosol-generating device. By way of example, the change in colour with respect to time may be useful in conveying data to a user indicating a change in temperature, such as a change in temperature of an electrical heating arrangement used to heat the aerosol-forming substrate.

The control electronics may be configured to selectively activate either or both of the outer and inner lighting areas to vary at least one of the first predetermined light emission and the second predetermined light emission with respect to time by one or more of activating, deactivating and reactivating different portions of the respective lighting area over time.

Preferably, each of the outer and inner lighting areas comprise a plurality of light emitting elements. However, as discussed in preceding paragraphs, the inner lighting area may have only a single lighting element. Each or different ones of the light emitting elements of the respective lighting area may contribute towards the first or second predetermined light emission according to which of the light emitting elements is activated by the control electronics at a given instant in time. All or only some of the light emitting elements may be used in the generating of the first or second predetermined light emission at a given instant in time. The use of light emitting elements in the form of light emitting diodes (LED's) is preferred due to LED's being energy efficient. It is preferred that the aerosol-generating device is sized so as to be handheld and to include a power source to provide portability. As previously indicated, the power source may conveniently be in the form of a rechargeable battery. In this context, the energy efficiency associated with LED's makes them particularly suitable for use in such a handheld portable aerosol-generating device having its own power source. Alternatively however, the light emitting elements may instead be comprised of one or more liquid crystal displays, or any other electrically powered light source whose energy and size requirements are suitable for use in an aerosol-generating device.

The aerosol-generating device may also further comprise one or more waveguides configured to direct light generated by one or more of the plurality of light emitting elements to one or more display windows of either or both of the outer lighting area and the inner lighting area for viewing of the first predetermined light emission and second predetermined light emission by a user. As used herein, the term “waveguide” denotes a structure adapted to guide electromagnetic waves of light. The one or more waveguides may conveniently be in the form of one or more optical fibres or light pipes. Conveniently, each of the light emitting elements may be associated with a corresponding waveguide, so that the light emitted from each light emitting element is conveyed to a display window via the corresponding waveguide.

Preferably, each one of the light emitting elements is a light emitting diode and the control electronics comprises a light emitting diode control driver and a separate microcontroller. The control driver may be configured to control a supply of electricity from a power source to one or more of the plurality of light emitting diodes under the control of the microcontroller, so as to generate the first predetermined light emission and the second predetermined light emission. The control driver may be configured to control one or both of the voltage or current level of the supply of electricity.

The plurality of light emitting diodes of each of the outer and inner lighting areas may comprise a first set of light emitting diodes configured to emit light of a first colour; and a second set of light emitting diodes configured to emit light of a second colour. The light emitting diode control driver may be configured to activate one or more of the light emitting diodes from the first set alone of either or both of the outer and inner lighting areas, or from the second set alone of either or both of the outer and inner lighting areas, or from both of the first and second sets of either or both of the outer and inner lighting areas, so as to control the colour of at least one of the first predetermined light emission and the second predetermined light emission.

The light emitting diode control driver may be configured to control a supply of electricity from a power source to one or more of the plurality of light emitting diodes of either or both of the outer and inner lighting areas by a pulse width modulation regime having a predetermined resolution, so as to control the luminance of at least one of the first predetermined light emission and the second predetermined light emission, in which the predetermined resolution defines two or more luminance levels. By way of example, the resolution of the pulse width modulation regime may be 8 bit (having 256 levels), 10 bit (having 1024 levels), or 12 bit (having 4096 levels). The higher the predetermined resolution, the greater the number of discrete static luminance levels of light which may be generated by a given light emitting diode. In this manner, the granularity or level of detail of data conveyed to the user through the different luminance levels may be controlled by the predetermined resolution chosen for the light emitting diode control driver.

According to another aspect of the present disclosure, there is provided an aerosol-delivery system comprising an aerosol-generating device according to any one of variants described above; and an aerosol-generating article comprising an aerosol-forming substrate.

The aerosol-generating article may extend over a length of 75 millimetres (+/−10%). The aerosol-generating article may have a diameter of 6.7 millimetres (+/−10%). The aerosol-generating article may have a mass of between 580 mg to 620 mg. However, it will be understood that the length, diameter, mass or shape of the aerosol-generating article may be chosen according to the likely preferences of the intended user.

Preferably, the aerosol-forming substrate is a solid aerosol-forming substrate. However, the aerosol-forming substrate may comprise both solid and liquid components. Alternatively, the aerosol-forming substrate may be a liquid aerosol-forming substrate.

Preferably, the aerosol-forming substrate comprises nicotine. More preferably, the aerosol-forming substrate comprises tobacco. Alternatively or in addition, the aerosol-forming substrate may comprise a non-tobacco containing aerosol-forming material.

If the aerosol-forming substrate is a solid aerosol-forming substrate, the solid aerosol-forming substrate may comprise, for example, one or more of: powder, granules, pellets, shreds, strands, strips or sheets containing one or more of: herb leaf, tobacco leaf, tobacco ribs, expanded tobacco and homogenised tobacco.

Optionally, the solid aerosol-forming substrate may contain tobacco or non-tobacco volatile flavour compounds, which are released upon heating of the solid aerosol-forming substrate. The solid aerosol-forming substrate may also contain one or more capsules that, for example, include additional tobacco volatile flavour compounds or non-tobacco volatile flavour compounds and such capsules may melt during heating of the solid aerosol-forming substrate.

Optionally, the solid aerosol-forming substrate may be provided on or embedded in a thermally stable carrier. The carrier may take the form of powder, granules, pellets, shreds, strands, strips or sheets. The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

In a preferred embodiment, the aerosol-forming substrate comprises homogenised tobacco material. As used herein, the term “homogenised tobacco material” refers to a material formed by agglomerating particulate tobacco.

Preferably, the aerosol-forming substrate comprises a gathered sheet of homogenised tobacco material. As used herein, the term “sheet” refers to a laminar element having a width and length substantially greater than the thickness thereof. As used herein, the term “gathered” is used to describe a sheet that is convoluted, folded, or otherwise compressed or constricted substantially transversely to the longitudinal axis of the aerosol-generating article.

Preferably, the aerosol-forming substrate comprises an aerosol former. As used herein, the term “aerosol former” is used to describe any suitable known compound or mixture of compounds that, in use, facilitates formation of an aerosol and that is substantially resistant to thermal degradation at the operating temperature of the aerosol-generating article.

Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine.

The aerosol-forming substrate may comprise a single aerosol former. Alternatively, the aerosol-forming substrate may comprise a combination of two or more aerosol formers.

The invention is defined in the claims. However, below there is provided a non-exhaustive list of non-limiting examples. Any one or more of the features of these examples may be combined with any one or more features of another example, embodiment, or aspect described herein.

Example Ex1: An aerosol-generating device for heating an aerosol-forming substrate to generate an inhalable aerosol during a usage session, the aerosol-generating device comprising: control electronics; and an annular outer lighting area or an inner lighting area, optionally the outer lighting area surrounds the inner lighting area; in which the control electronics are coupled to the outer lighting area and/or the inner lighting area and configured to: i) selectively illuminate the outer lighting area or the inner lighting area to generate a first predetermined light emission conveying first data indicative of a state of the aerosol-generating device; and/or ii) selectively illuminate the outer lighting area or the inner lighting area to generate a second predetermined light emission conveying second data indicative of a state of the aerosol-generating device, optionally the first data and the second data are different from one another.

Example Ex1a: An aerosol-generating device according to Ex1, further comprising:
an opening defined in a wall of the aerosol-generating device;
one or more lighting elements positioned within the aerosol-generating device;
a light transmissive pathway optically coupling the one or more lighting elements to the opening;
the control electronics configured to selectively activate at least one of the one or more light elements to generate one or both of the first and second predetermined light emissions.

Example Ex1b: An aerosol-generating device according to Ex1a, in which the light transmissive pathway comprises a diffuser or waveguide.

Example Ex1c: An aerosol-generating device according to Ex1b, in which the diffuser or waveguide is mechanically coupled to an interior surface of the wall.

Example Ex1d: An aerosol-generating device according to Ex1c, in which the diffuser or waveguide is also mechanically coupled to at least one of the one or more lighting elements.

Example Ex1e: An aerosol-generating device according to any one of Ex1b to Ex1d, in which no part of the diffuser or waveguide protrudes into the opening.

Example Ex1f: An aerosol-generating device according to any one of Ex1a to Ex1d, in which at least a portion of the diffuser or waveguide protrudes into all or a portion of the opening.

Example Ex1g: An aerosol-generating device according to Ex1f, in which the diffuser or waveguide protrudes into the opening such that the diffuser or waveguide is flush with an exterior surface of the wall.

Example Ex1h: An aerosol-generating device according to any one of Ex1a to Ex1g, in which the opening is an annular opening defining the annular outer lighting area.

Example Ex1i: An aerosol-generating device according to Ex1h, in which an inward peripheral edge of the annular opening is defined by a portion of material impervious to light transmission, the annular opening surrounding the portion of material.

Example Ex1j: An aerosol-generating device according to Ex1h, in which an inward peripheral edge of the annular opening is defined by a portion of material wholly or partially transmissive to light, the annular opening surrounding the portion of material, the portion of material defining the inner lighting area.

Example Ex2: An aerosol-generating device according to any one of Ex1 to Ex1j, in which the outer lighting area and the inner lighting area collectively form a common lighting array.

Example Ex3: An aerosol-generating device according to Ex2, in which the common lighting array comprises a plurality of lighting elements, in which the control electronics are configured to: control a first subset of the plurality of lighting elements of the common lighting array to generate the first light emission; and control a second subset of the plurality of lighting elements of the common lighting array to generate the second light emission.

Example Ex4: An aerosol-generating device according to any one of Ex1 to Ex3, in which the inner lighting area comprises a single lighting element.

Example Ex5: An aerosol-generating device according to Ex4, in which the single lighting element is centrally positioned in the inner lighting area.

Example Ex6: An aerosol-generating device according to any one of Ex1 to Ex3, in which the inner lighting area comprises a group of lighting elements, the group of lighting elements arranged in a circular pattern about a centre of the inner lighting area.

Example Ex7: An aerosol-generating device according to any one of Ex1 to Ex6, in which either or both of the outer and inner lighting areas is semi-opaque.

Example Ex7a: An aerosol-generating device according to Ex7, in which a display window of either or both of the outer and inner lighting areas is semi-opaque.

Example Ex8: An aerosol-generating device according to any one of Ex1 to Ex7a, in which the aerosol-generating device extends longitudinally between first and second ends, wherein the outer and inner lighting areas are provided on a lateral surface defining one of the first and second ends.

Example Ex9: An aerosol-generating device according to any one of Ex1 to Ex8, in which the device comprises a first housing and a second housing.

Example Ex10: An aerosol-generating device according to Ex9, in which the first housing is detachably couplable to the second housing.

Example Ex11: An aerosol-generating device according to either one of Ex9 or Ex10, in which the first housing defines or comprises a holder for an aerosol-generating article comprising an aerosol-forming substrate.

Example Ex12: An aerosol-generating device according to Ex11, in which the holder comprises an inductive heating arrangement.

Example Ex12a: An aerosol-generating device according to Ex11, in which the holder comprises a resistive heating arrangement.

Example Ex12b: An aerosol-generating device according to any one of Ex9 to Ex12a, in which the second housing extends longitudinally between first and second ends, wherein the outer and inner lighting areas are provided on a lateral surface defining one of the first and second ends.

Example Ex13: An aerosol-generating device according to any one of Ex9 to Ex12b, in which the second housing comprises one or more of: a power source, control circuitry for controlling a heating arrangement, and one or more buttons accessible from outside of the second housing.

Example Ex14: An aerosol-generating device according to Ex13, in which at least one of the one or more buttons is operable to select, activate, change, pause or deactivate an operating mode of the aerosol-generating device, the button coupled to the control electronics such that the first or second predetermined light emission is indicative of the operating mode that is selected, activated, changed, paused or deactivated by operation of the button.

Example Ex15: An aerosol-generating device according to Ex14, in which the operating mode comprises one or more of a pre-heating mode and a pause mode.

Example Ex16: An aerosol-generating device according to any one of Ex13 to Ex15, in which the one or more buttons consist of a first button and a second button.

Example Ex17: An aerosol-generating article according to any one of Ex1 to Ex16, in which at least one of the first and second data is indicative of any one of: a) the aerosol-generating device having been activated by a user; b) selection, activation, changing, pausing, deactivating or progression of an operating mode of the aerosol-generating device; c) an energy level of a power source of the aerosol-generating device; d) a power source of the aerosol-generating device containing sufficient energy to complete a single usage session; e) a power source of the aerosol-generating device containing sufficient energy to complete two or more usage sessions; f) a power source of the aerosol-generating device containing a level of energy below a predetermined threshold level of energy; g) selection or activation of one of a first predetermined thermal profile and a second predetermined thermal profile, in which each of the first and second predetermined thermal profiles define a heating profile for heating of the aerosol-forming substrate by an electrical heating arrangement over the usage session, the first and second predetermined thermal profiles being different to each other; h) the aerosol-generating device being in one of a pause mode state or a reactivation state; i) selection or activation of a change in operational state of the aerosol-generating device; j) progression through the usage session; and k) progression through a pre-heating phase in which an electrical heating arrangement is heated to a predetermined target temperature.

Example Ex18: An aerosol-generating device according to any one of Ex1 to Ex17, in which the first data relates to a state of progression of an operational phase of the aerosol-generating device, the second data relates to a different state of the aerosol-generating device, the first predetermined light emission is a predetermined phase progression light emission, and the second predetermined light emission is a predetermined state light emission; wherein the control electronics are configured to: i) selectively activate one of the outer and inner lighting areas to generate the predetermined phase progression light emission indicative of and in response to progression of the operational phase of the aerosol-generating device; and ii) selectively activate the other of the outer and inner lighting areas to generate the predetermined state light emission indicative of and in response to the different state of the aerosol-generating device.

Example Ex19: An aerosol-generating device according to Ex18, in which the operational phase is a pre-heating phase in which an electrical heating arrangement for heating of the aerosol-forming substrate is heated to a predetermined target temperature.

Example Ex20: An aerosol-generating device according to Ex18, in which the operational phase is the usage session.

Example Ex21: An aerosol-generating device according to any one of Ex18 to Ex20, in which the control electronics are configured to: i) selectively activate the outer lighting area to generate the predetermined phase progression light emission; and ii) selectively activate the inner lighting area to generate the predetermined state light emission.

Example Ex22: An aerosol-generating device according to any one of Ex18 to Ex21, in which the control electronics are configured to generate the predetermined phase progression light emission and the predetermined state light emission simultaneously.

Example Ex23: An aerosol-generating device according to any one of Ex18 to Ex22, in which the control electronics are configured to progressively reduce or progressively increase an activated area of one of the outer lighting area and the inner lighting area with progression through the operational phase of the aerosol-generating device to generate the predetermined phase progression light emission.

Example Ex24: An aerosol-generating device according to any one of Ex18 to Ex23, in which the control electronics are configured to vary an activated thickness of the annular outer lighting area with respect to time in generating either of the predetermined phase progression light emission or the predetermined state light emission.

Example Ex25: An aerosol-generating device according to any one of Ex18 to Ex24, in which at least one of the outer lighting area and the inner lighting area is formed of distinct first and second portions, in which the control electronics are configured to: progressively reduce or progressively increase an activated area of the first portion with progression through a first usage session to generate a predetermined first usage session light emission; and progressively reduce or progressively increase an activated area of the second portion with progression through a second usage session to generate a predetermined second usage session light emission.

Example Ex26: An aerosol-generating device according to Ex25, in which the distinct first and second portions are symmetrically disposed on opposed sides of a bisector of the respective outer and inner lighting area.

Example Ex27: An aerosol-generating device according to any one of Ex1 to Ex26, in which the control electronics are configured to: activate a first proportion of one of the outer and inner lighting areas to generate a predetermined first state light emission indicative of and in response to the aerosol-generating device being in a first state; and activate a second proportion of the respective lighting area to generate a predetermined second state light emission indicative of and in response to the aerosol-generating device being in a second state; in which the second proportion is greater in size than the first proportion.

Example Ex28: An aerosol-generating device according to Ex27, the aerosol-generating device further comprising: a power source coupled to the control electronics; in which the first state corresponds to the power source containing sufficient energy to complete a single usage session, and the second state corresponds to the power source containing sufficient energy to complete two or more usage sessions.

Example Ex29: An aerosol-generating device according to Ex27, the aerosol-generating device further comprising: a power source coupled to the control electronics; in which the first state corresponds to activation by the control electronics of a first predetermined thermal profile for heating of the aerosol-forming substrate by an electrical heating arrangement over the usage session, and the second state corresponds to activation by the control electronics of a second predetermined thermal profile for heating of the aerosol-forming substrate by the electrical heating arrangement over the usage session.

Example Ex30: An aerosol-generating device according to any one of Ex18 to Ex29, in which the control electronics are configured to selectively activate different parts of one of the outer lighting area and the inner lighting area over time such that an activated portion of the respective lighting area travels along the lighting area over time to generate one of the predetermined phase progression light emission and the predetermined state light emission.

Example Ex31: An aerosol-generating device according to Ex30, wherein the state of the aerosol-generating device to which the predetermined state light emission corresponds is a reactivation state or a pause mode state.

Example Ex32: An aerosol-generating device according to Ex31, in which the reactivation state corresponds to the control electronics controlling a supply of energy from a power source to an electrical heating arrangement to heat the aerosol-forming substrate at a first temperature level in an aerosol-releasing mode, and the pause mode state corresponds to the control electronics controlling the supply of energy from the power source to the electrical heating arrangement to heat the aerosol-forming substrate at a second temperature level below the first temperature level.

Example Ex33: An aerosol-generating device according to any one of Ex18 to Ex32, in which the control electronics are configured to progressively increase a dominant wavelength of the predetermined phase progression light emission with progression through the operational phase of the aerosol-generating device.

Example Ex34: An aerosol-generating device according to Ex33, in which the dominant wavelength is in the range 380 to 500 nanometres at a start of the operational phase and is in the range 590 to 700 nanometres at an end of the operational phase.

Example Ex35: An aerosol-generating device according to any one of Ex1 to Ex34, in which a predetermined area of the inner lighting area defines a predetermined shape, the control electronics configured to activate the predetermined area defining the predetermined shape to generate either of the first predetermined light emission or the second predetermined light emission.

Example Ex36: An aerosol-generating device according to any one of Ex1 to Ex35, the aerosol-generating device comprising a touch-activated interface, the touch-activated interface coupled to the control electronics and comprising an activation area contactable by a user's digit so as to provide a user input to the control electronics. Example Ex37: An aerosol-generating device according to Ex36, in which the touch-activated interface forms part of either or both of the outer lighting area and the inner lighting area.

Example Ex38: An aerosol-generating device according to Ex36, in which the activation area is defined between the outer lighting area and the inner lighting area.

Example Ex39: An aerosol-generating device according to any one of Ex36 to Ex38, in which the touch-activated interface comprises a capacitive panel.

Example Ex40: An aerosol-generating device according to any one of Ex1 to Ex39, in which the control electronics are configured to selectively activate either or both of the outer and inner lighting areas at two or more luminance levels, so as to vary the luminance with respect to time of at least one of the first predetermined light emission and the second predetermined light emission.

Example Ex41: An aerosol-generating device according to any one of Ex1 to Ex40, in which the control electronics are configured to selectively activate either or both of the outer and inner lighting areas in two or more colour states, so as to vary the colour with respect to time of at least one of the first predetermined light emission and the second predetermined light emission.

Example Ex42: An aerosol-generating device according to any one of Ex1 to Ex41, in which the control electronics are configured to selectively activate either or both of the outer and inner lighting areas to vary at least one of the first predetermined light emission and the second predetermined light emission with respect to time by one or more of activating, deactivating and reactivating different portions of the respective lighting area over time.

Example Ex43: An aerosol-generating device according to any one of Ex1 to Ex42, in which each of the outer and inner lighting areas comprise a plurality of light emitting elements.

Example Ex44: An aerosol-generating device according to Ex43, further comprising one or more waveguides configured to direct light generated by one or more of the plurality of light emitting elements to one or more display windows of either or both of the outer lighting area and the inner lighting area for viewing of the first predetermined light emission and second predetermined light emission by a user.

Example Ex45: An aerosol-generating device according to either one of Ex43 or Ex44, wherein each one of the light emitting elements is a light emitting diode and the control electronics comprises a light emitting diode control driver and a separate microcontroller, the control driver configured to control a supply of electricity from a power source to one or more of the plurality of light emitting diodes under the control of the microcontroller, so as to generate the first predetermined light emission and the second predetermined light emission.

Example Ex46: An aerosol-generating device according to Ex45, in which the plurality of light emitting diodes of each of the outer and inner lighting areas comprises: a first set of light emitting diodes configured to emit light of a first colour; and a second set of light emitting diodes configured to emit light of a second colour; in which the light emitting diode control driver is configured to activate one or more of the light emitting diodes from the first set alone of either or both of the outer and inner lighting areas, or from the second set alone of either or both of the outer and inner lighting areas, or from both of the first and second sets of either or both of the outer and inner lighting areas, so as to control the colour of at least one of the first predetermined light emission and the second predetermined light emission.

Example Ex47: An aerosol-generating device according to either one of Ex45 or Ex46, in which the light emitting diode control driver is configured to control a supply of electricity from a power source to one or more of the plurality of light emitting diodes of either or both of the outer and inner lighting areas by a pulse width modulation regime having a predetermined resolution, so as to control the luminance of at least one of the first predetermined light emission and the second predetermined light emission, in which the predetermined resolution defines two or more luminance levels.

Example Ex48: An aerosol-delivery system comprising:
an aerosol-generating device according to any one of Ex1 to Ex47; and
an aerosol-generating article comprising an aerosol-forming substrate.

Example Ex49: An aerosol-delivery system according to Ex48, in which the aerosol-generating article extends over a length of 75 millimetres (+/−10%).

Example Ex50: An aerosol-delivery system according to either one of Ex48 or Ex49, in which the aerosol-generating article has a diameter of 6.7 millimetres (+/−10%).

Example Ex51: An aerosol-delivery system according to any one of claims Ex48 to Ex50, in which the aerosol-generating article has a mass of between 580 mg and 620 mg.

Examples will now be further described with reference to the figures, in which:

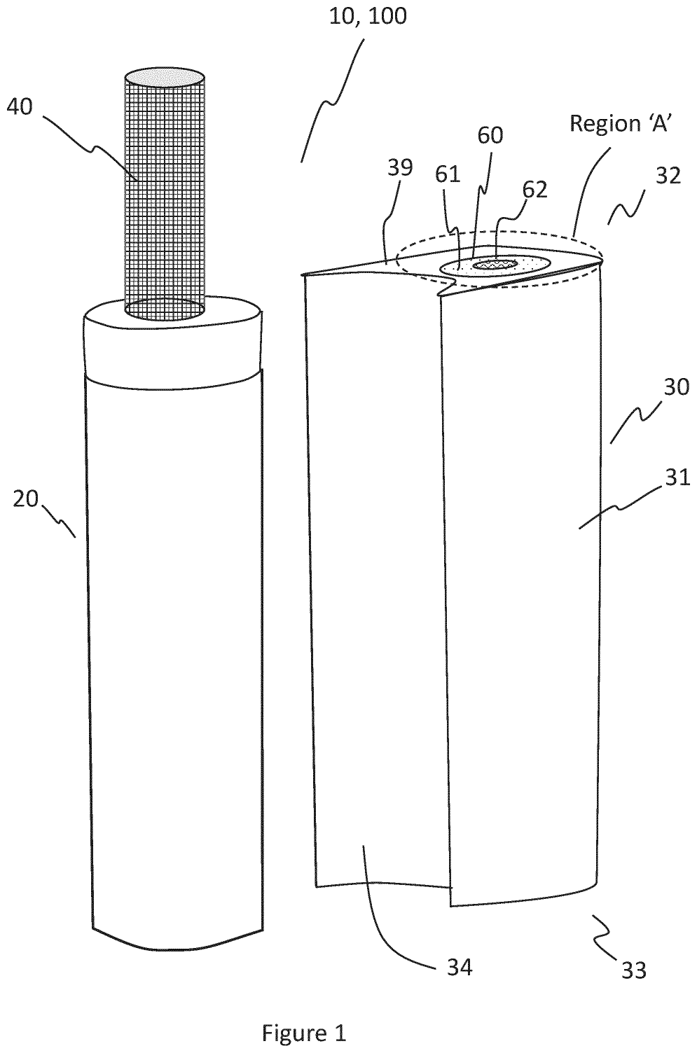

FIG. 1 illustrates a schematic perspective view of an aerosol-generating device having a first housing and a second housing, in which the first and second housings are uncoupled from each other;

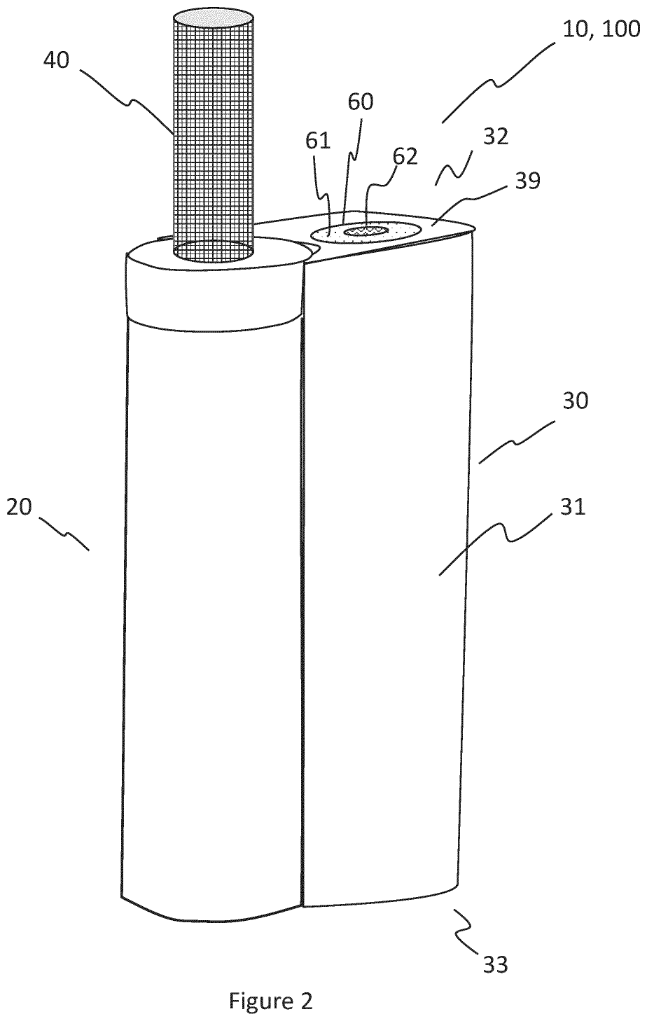

FIG. 2 illustrates a schematic perspective view of the aerosol-generating device of FIG. 1, but showing the first and second housings coupled to each other.

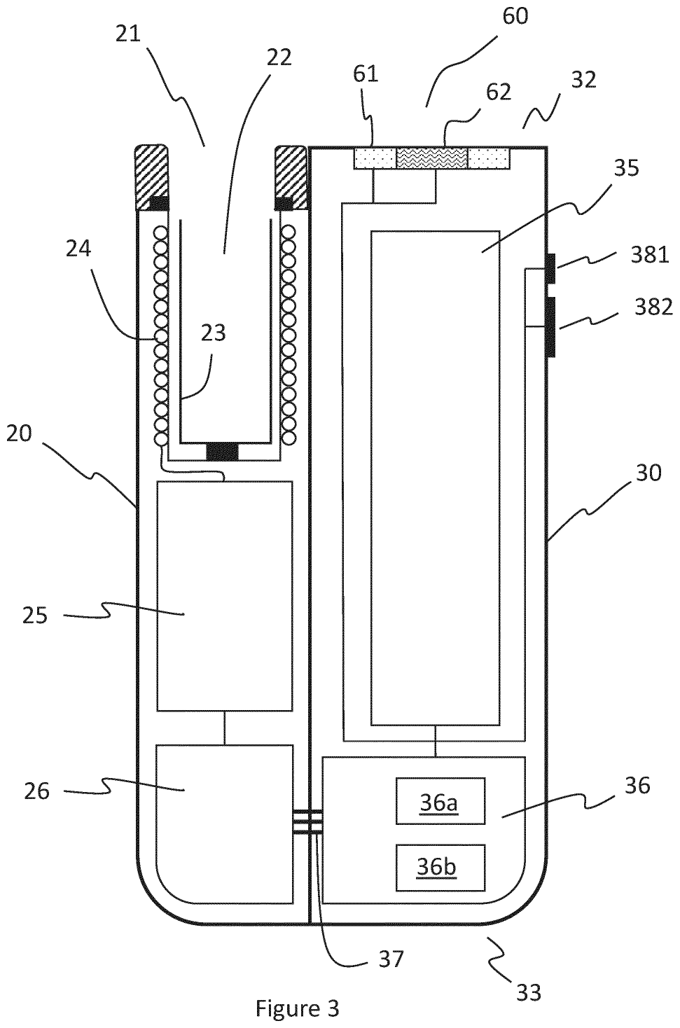

FIG. 3 illustrates a schematic cross-section side view of the aerosol-generating device of FIG. 2, showing the various components of the aerosol-generating device;

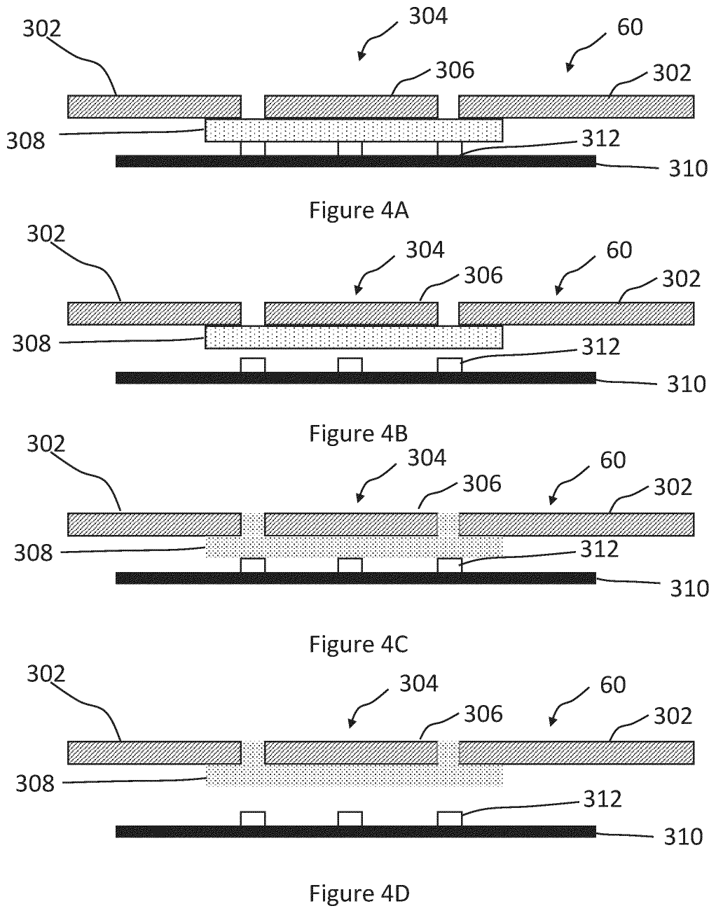

FIGS. 4A to 4D illustrate schematic representations of different examples of an embodiment of a display of the aerosol-generating device;

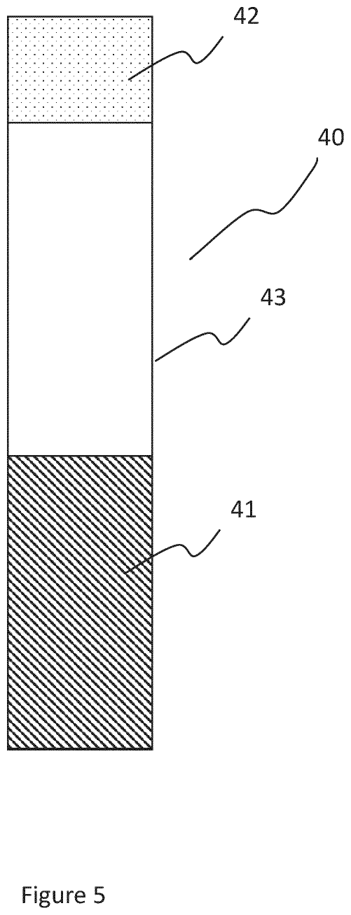

FIG. 5 is a schematic cross-section side view of an aerosol-generating article for use with the aerosol-generating device of FIGS. 1 to 3;

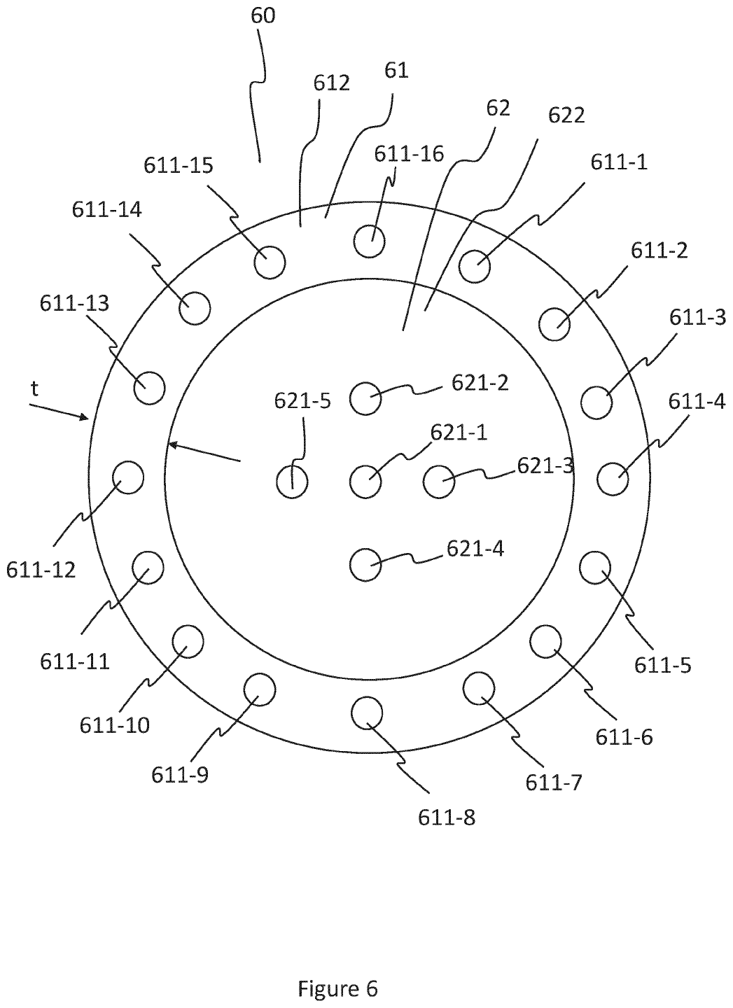

FIG. 6 is a schematic plan view of another embodiment of a display provided on a lateral end face of one of the housings of the aerosol-generating device (corresponding to Region ‘A’ of FIG. 1), in which an annular outer lighting area surrounds an inner lighting area;

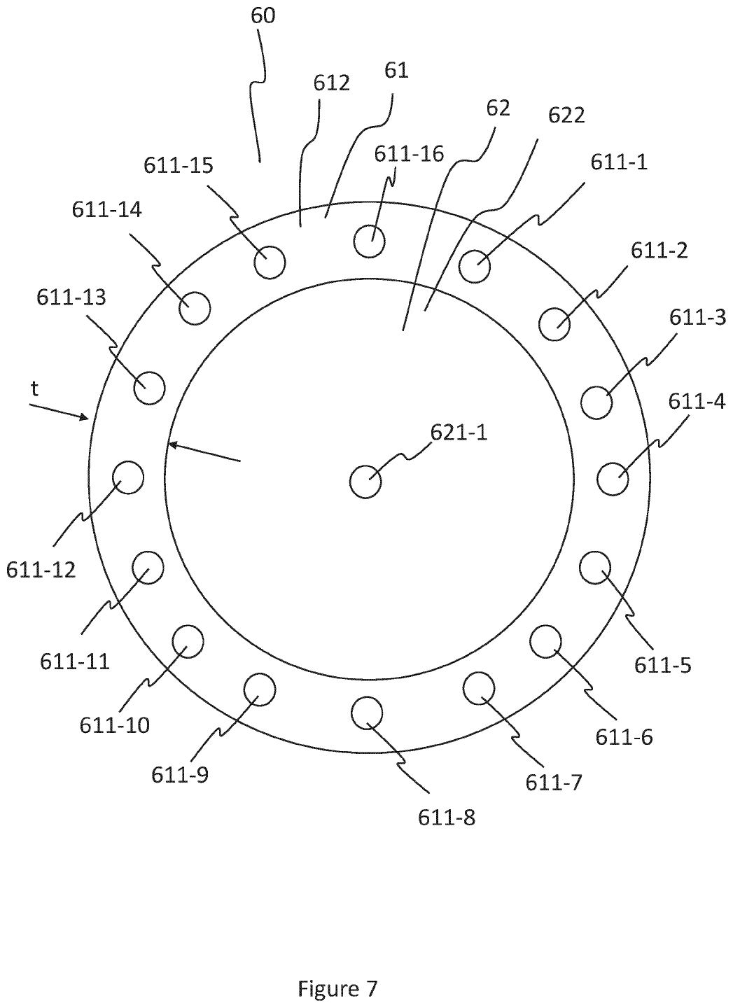

FIG. 7 is a schematic plan view of another embodiment of a display provided on a lateral end face of one of the housings of the aerosol-generating device (corresponding to Region ‘A’ of FIG. 1), in which an annular outer lighting area surrounds an inner lighting area;

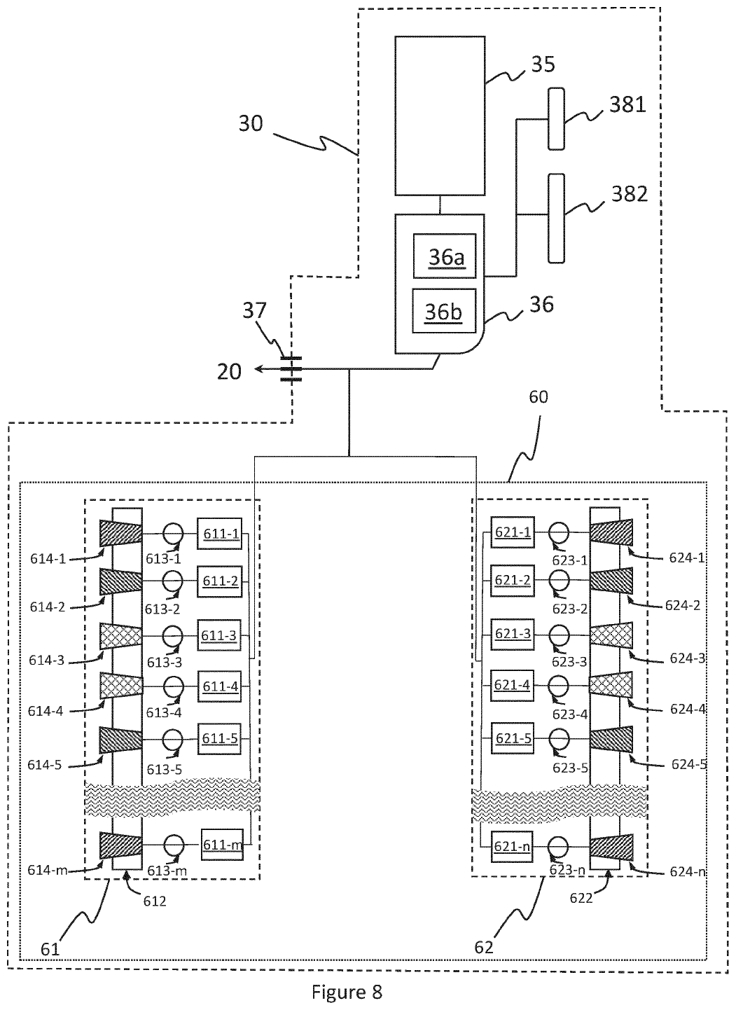

FIG. 8 is a block diagram providing a schematic illustration of various components within the second housing of the aerosol-generating device of FIGS. 1 to 3 and their interactions;

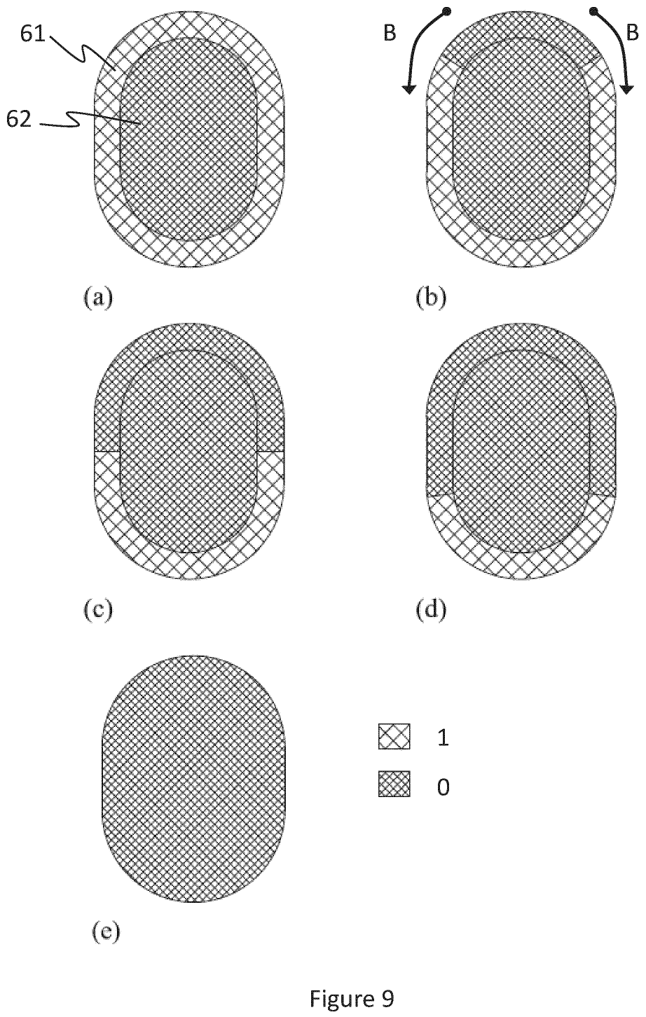

FIG. 9 illustrates an example of how a lighting control driver of the aerosol-generating device controls a supply of energy to the annular outer lighting area of the display to generate a predetermined light emission indicative of progression through a usage session.

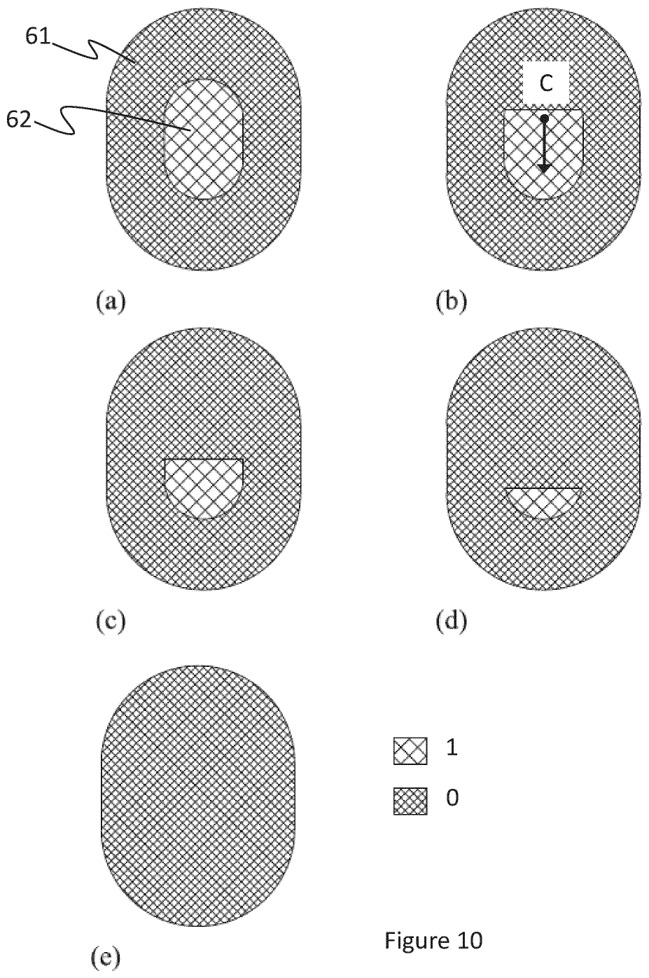

FIG. 10 illustrates an example of how the lighting control driver of the aerosol-generating device controls a supply of energy to the inner lighting area of the display to generate a predetermined light emission indicative of progression through a usage session.

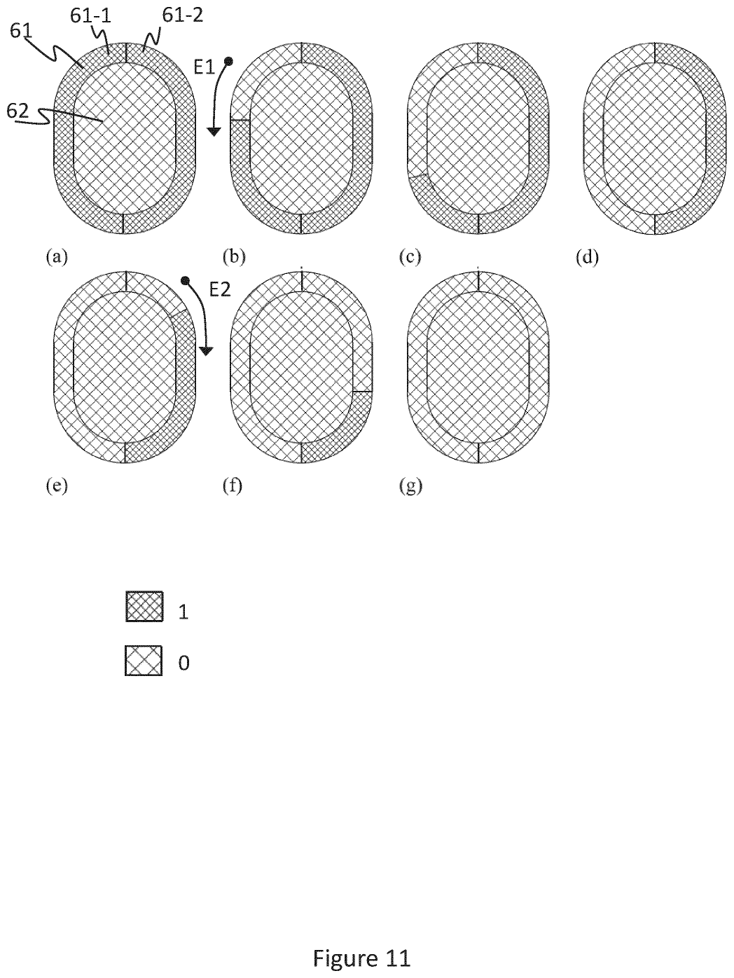

FIG. 11 illustrates an example of how the lighting control driver of the aerosol-generating device controls a supply of energy to the outer lighting area of the display to generate predetermined light emissions indicative of progression through distinct first and second usage sessions.

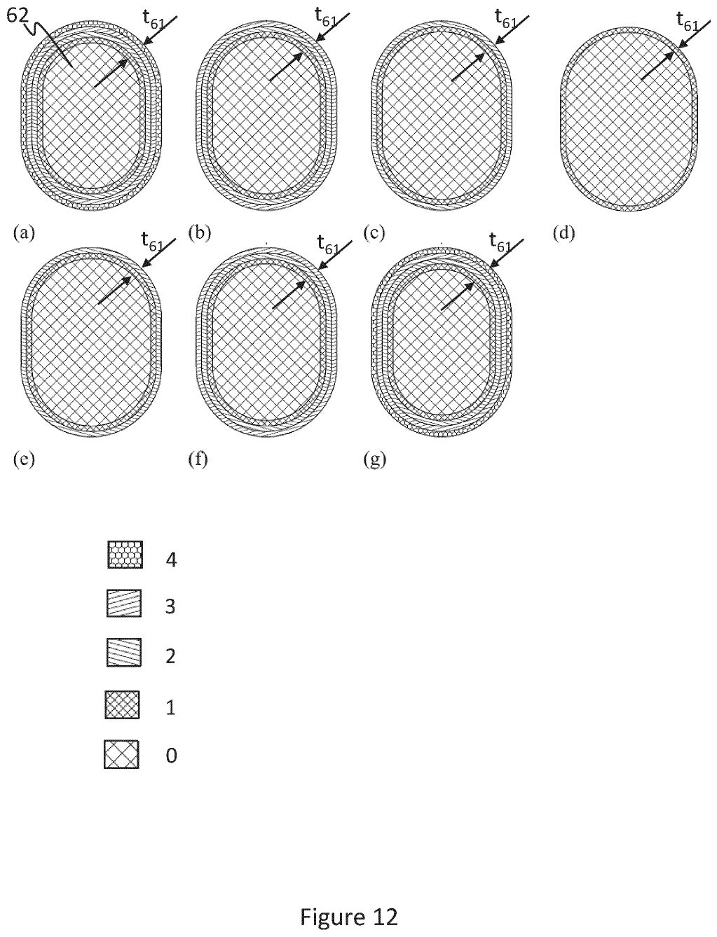

FIG. 12 illustrates an example of how the lighting control driver of the aerosol-generating device controls a supply of energy to the outer lighting area of the display to generate a predetermined light emission indicative of progression through a pre-heating phase of operation.

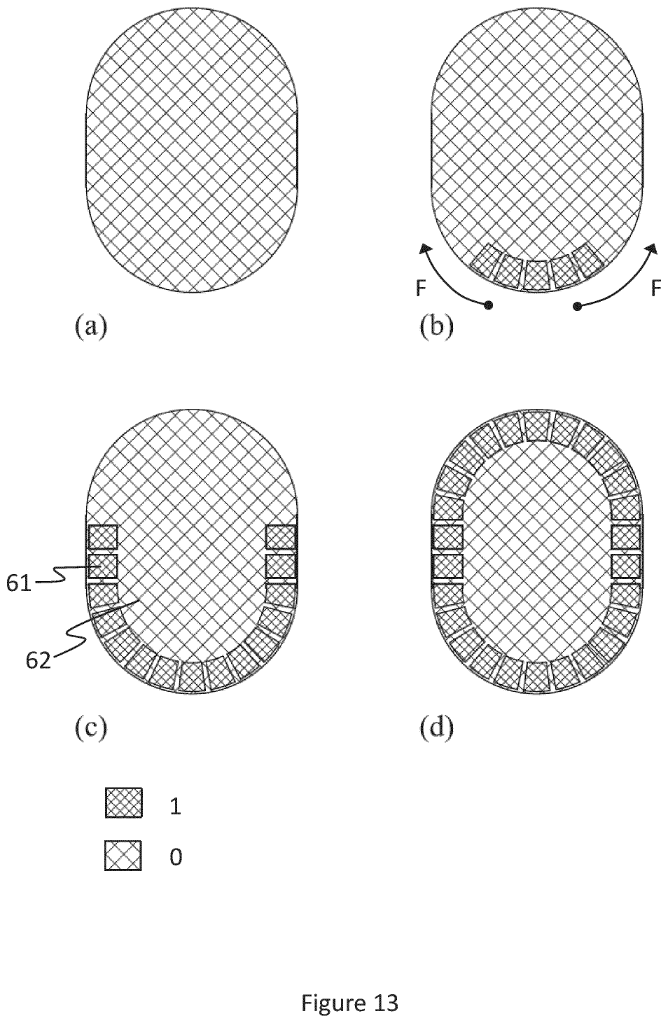

FIG. 13 illustrates an example of how the lighting control driver of the aerosol-generating device controls a supply of energy to the outer lighting area to generate a predetermined light emission indicative of progression through the pre-heating phase of operation.

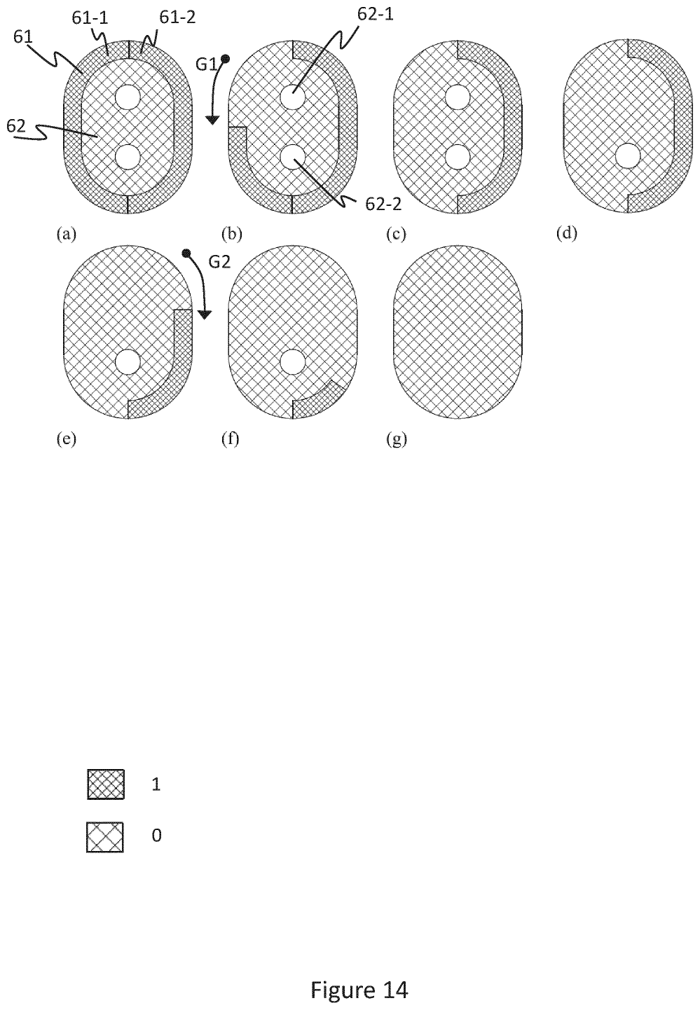

FIG. 14 illustrates an example of how the lighting control driver of the aerosol-generating device controls a supply of energy to the outer lighting area of the display to generate predetermined light emissions indicative of progression through distinct first and second usage sessions, whilst also controlling a supply of energy to the inner lighting area to generate predetermined light emissions indicative of an energy level of a power source of the device.

An exemplary aerosol-generating device 10 is a two-part hand-held aerosol generating device formed of a first housing 20 and a second housing 30 (see FIGS. 1 and 2). The first and second housings 20, 30 are designed to detachably couple with each other.

The first housing 20 is in the form of an elongate cylinder. An opening 21 is provided at one end of the first housing 20 (see FIG. 3) for receiving an aerosol-generating article 40 within a cavity 22 defined within the first housing. In this manner, the first housing 20 serves as a holder for the aerosol-generating article 40. As shown in FIG. 3, a tubular susceptor element 23 defines a cylindrical wall of the cavity 22. The tubular susceptor element 23 is formed of ferromagnetic material, such as stainless steel and nickel. As also shown in FIG. 3, an induction coil 24 surrounds the tubular susceptor element 23. The induction coil 24 is both tubular and helical, and defines a circular cross section when viewed along the longitudinal axis of the first housing 20. The induction coil 24 and tubular susceptor element 23 both extend along most of the length of the cavity 22 and together form an induction heating assembly for the aerosol-generating device 10. The induction coil 24 is coupled to an auxiliary power source 25 provided within the first housing 20. The auxiliary power source 25 is in the form of a lithium-ion battery or similar. Auxiliary controller 26 is also provided in the first housing 20 and is coupled to the auxiliary power source 25.

The second housing 30 is generally elongate, having a sidewall 31 which extends between opposed first and second ends 32, 33. A cut-out or recess 34 (see FIG. 1) is provided in the sidewall 31. The second housing 30 includes a primary power source 35 and primary controller 36. The primary controller 36 includes or is operably coupled to a memory module 36a and lighting control driver 36b. The primary power source 35 is in the form of a lithium-ion battery or similar, but possessing a larger energy capacity than that of the auxiliary power source 25. The cut-out or recess 34 is profiled with a curvature corresponding to the curvature of the cylindrical sidewall of the first housing 20, thereby enabling the first and second housings 20, 30 to be mated to each other in a side-by-side relationship. The first and second housings 20, 30 are each formed with electrical interconnections such that when the first housing 20 is received within the cut-out or recess 34 of the second housing 30, an electrical interface 37 (see FIG. 3) is formed between the first housing 20 and the second housing 30. The primary power source 35 and primary controller 36 of the second housing 30 are operably coupled to the auxiliary power source 25 and auxiliary controller 26 of the first housing 20 via the electrical interface 37. First and second buttons 381, 382 are provided in cut-outs defined in the sidewall 31 of the second housing 30 and protrude from the housing 30 to be accessible to a user. The first and second buttons 381, 382 are operably coupled to the primary controller 36. A display 60 is incorporated on a lateral end face 39 of the second housing 30. The display 60 is formed of an annular outer lighting area 61 and an inner lighting area 62. The annular outer lighting area 61 defines a closed ring surrounding the inner lighting area 62. The display 60 is operably coupled to the primary controller 36. Features and characteristics of the display 60 are discussed in more detail in subsequent paragraphs.

FIGS. 4A to 4D illustrate examples of an embodiment of a display 60. In these examples, the second housing 30 has a top wall 302 which comprises an opening 304 through which light is emitted. The opening 304 may be circular or oval. Within the opening 304 there is a piece 306 which is smaller than the opening 304. The piece 306 may be circular or oval. A gap is formed between the outside edge of the piece 306 and the inside edge of the opening 304 through which light is emitted.

Beneath the piece 306 there is a waveguide or light-diffuser 308. Beneath the waveguide or light-diffuser 308 there is a printed circuit board (PCB) 310 comprising a plurality of surface-mounted light emitting diodes (LEDs) 312. The primary controller 35 selectively illuminates the LEDs 312 to convey information about the status of the device 10 to the user. The light from the LEDs 312 passes through the waveguide or light-diffuser 308 and is emitted through the gap between the outside edge of the piece 306 and the inside edge of the opening 304. In addition, piece 306 may be translucent or transparent such that light can be emitted therethrough.

In FIG. 4A, the LEDs 312 are mechanically and optically coupled to the waveguide or light-diffuser 308. In addition, there is an air gap between the outside edge of the piece 306 and the inside edge of the opening 304.

In FIG. 4B, the LEDs 312 are not directly mechanically coupled to the waveguide or light-diffuser 308. However, the LEDs are optically coupled to the waveguide or light-diffuser 308. Again, there is an air gap between the outside edge of the piece 306 and the inside edge of the opening 304.

In FIG. 4C, the LEDs 312 are mechanically and optically coupled to the waveguide or light-diffuser 308. In this example, the waveguide or light-diffuser 308 extends between the outside edge of the piece 306 and the inside edge of the opening 304.

In FIG. 4D, the LEDs 312 are not directly mechanically coupled to the waveguide or light-diffuser 308. However, the LEDs are optically coupled to the waveguide or light-diffuser 308. In this example, the waveguide or light-diffuser 308 extends between the outside edge of the piece 306 and the inside edge of the opening 304.

As shown in FIG. 5, the aerosol-generating article 40 intended for insertion into the cavity 22 of the first housing 20 of the aerosol-generating device 10 has the form of a cylindrical rod, the rod formed by a combination of an aerosol-forming substrate 41 and a filter element 42. The aerosol-forming substrate 41 and filter element 42 are co-axially aligned and enclosed in a wrapper 43 of cigarette paper. The aerosol-forming substrate 41 is a solid aerosol-forming substrate comprising tobacco. However, in alternative embodiments (not shown), the aerosol-forming substrate 41 may instead be a liquid aerosol-forming substrate or formed of a combination of liquid and solid aerosol-forming substrates. The filter element 42 serves as a mouthpiece of the aerosol-generating article 40 and defines a downstream end of the article. The aerosol-generating article 40 has a diameter substantially equal to the diameter of the cavity 22 and a length longer than a depth of the cavity 22.

The aerosol-generating article 40 is inserted into the cavity 22 of the first housing 20 via opening 21. When the aerosol-generating article 40 is fully inserted into the cavity 22, the aerosol-forming substrate 41 is surrounded by the susceptor element 23 and the induction coil 24; the portion of the article 40 containing the filter element 42 extends outside of the cavity 22 and may be drawn on by a user, in a similar manner to a conventional cigarette.

The combination of the aerosol-generating device 10 and the aerosol-generating article 40 forms an aerosol-delivery system 100 (see FIGS. 1 and 2).

FIG. 6 illustrates a plan view of one embodiment of the display 60. For the embodiment shown in FIG. 6, both the annular outer lighting area 61 and the inner lighting area 62 are generally circular in shape. However, in other embodiments, the outer and inner lighting areas 61, 62 may be oval in shape, or any other shape in which the outer lighting area 61 surrounds the inner lighting area 62. The outer and inner lighting areas form part of a common lighting array. The outer lighting area 61 illustrated in FIG. 6 includes an annular arrangement of a plurality of light emitting diodes 611-1 . . . m (where m=16 for the embodiment shown). Although the schematic representation of FIG. 6 only shows a single light emitting diode across the thickness, t, of the annular outer lighting area 61, in other embodiments a plurality of light emitting diodes may be arranged across the thickness of the lighting area 61. The inner lighting area 62 includes a circular arrangement of a group of light emitting diodes 621-1 . . . n (where n=5), in which a first diode 621-1 is positioned in the centre of the inner lighting area 62 and is surrounded by the remaining four light emitting diodes 621-2 . . . 5. It will be appreciated that in other embodiments, the number of light emitting diodes in the outer and inner lighting areas 61, 62 may be greater or less than the number illustrated in FIG. 6. By way of example, FIG. 7 illustrates an embodiment of the display 60 in which the inner lighting area 62 has only a single, centrally located light emitting diode 621-1.

Each of the outer and inner lighting areas 61, 62 have a respective display window 612, 622 integrated into the lateral end face 39 of the second housing 30. The display windows 612, 622 are each semi-opaque, being partially transparent to light emitted from the light emitting diodes 611-1 . . . m and 621-1 . . . n.

As will be described in more detail below with reference to FIG. 8, in use, light generated by the light emitting diodes of the outer and inner lighting areas 61, 62 is directed towards the respective display window 612, 622 so as to be visible to a user of the aerosol-generating device 10.

As shown in FIG. 8, lighting control driver 36b is coupled (via the primary controller 36) to each of the light emitting diodes 611-1 . . . m of the outer lighting area 61 and each of the light emitting diodes 621-1 . . . n of the inner lighting area 62. For the annular outer lighting area 61, waveguides 613-1 . . . m are provided between the light emitting diodes 611-1 . . . m and the display window 612. Similarly, for the inner lighting area 62, waveguides 623-1 . . . n are provided between the light emitting diodes 621-1 . . . n and the display window 622. Each one of the waveguides 613-1 . . . m, 623-1 . . . n is associated with a respective one of the light emitting diodes 611-1 . . . m, 621-1 . . . n of the respective lighting area 61, 62. The association is such that, in use, each waveguide functions to direct light generated by an associated one of the light emitting diodes to the respective display window 612, 622. The waveguides 613-1 . . . m, 623-1 . . . n are in the form of discrete lengths of optical fibre.

The primary controller 36 controls a supply of energy to the lighting control driver 36b. In turn, the lighting control driver 36b individually controls a supply of electricity to each of the light emitting diodes 611-1 . . . m, 621-1 . . . n of the outer and inner lighting areas 61, 62 of the display 60, such that each light emitting diode emits light 614-1 . . . m, 624-1 . . . n at one of a plurality of discrete static luminance levels under the control of the lighting control driver (see FIG. 8). The light emitted by different lighting emitting diodes of the annular outer lighting area 61 under the control of the lighting control driver 36b together forms a predetermined light emission from that lighting area. Similarly, the light emitted by different light emitting diodes of the inner lighting area 62 under the control of the lighting control driver 36b together forms a predetermined light emission from that lighting area. The three different forms of cross-hatching used in FIG. 8 for the light 614-1 . . . m, 624-1 . . . n generated by different ones of the light emitting diodes of the outer and inner lighting areas 61, 62 of the display 60 represent three different static luminance levels.

The memory module 36a contains instructions for execution by the primary controller 36 and lighting control driver 36b during use of the device 10. The instructions stored in the memory module 36a include data on two or more user-selectable predetermined thermal profiles for the susceptor element 23, criteria determining the duration of a usage session, plus other data and information relevant to control and operation of the aerosol-generating device 10.

When the first and second housings 20, 30 are coupled together via electrical interface 37, the primary controller 36 supplies energy from the primary power supply 35 to the second housing 20 to charge up the auxiliary power source 25 in a charging mode. The charging of the auxiliary power supply 25 is controlled through instructions contained in the memory module 36a of the primary controller 36. However, in an alternative embodiment, the charging is instead controlled by instructions contained in the auxiliary controller 26. Initiation and progression of the charging mode of operation results in the lighting control driver 36b operating one or both of outer and inner lighting areas 61, 62 to provide a predetermined light emission visible to the user. The predetermined light emission corresponds to the charging mode of operation. This predetermined light emission may vary with time during charging to indicate progression of the charging mode of operation, thereby providing information to the user of the energy level of the auxiliary power supply 25.

On pressing one of buttons 381, 382, the primary controller 36 accesses the instructions contained in the memory module 36a and communicates with the auxiliary controller 26 to instruct the auxiliary controller 26 to supply energy from the auxiliary power supply 25 to the induction coil 24, thereby inducing a pre-heating phase of operation of the susceptor element 23. One or both of the primary and auxiliary controllers 36, 26 may include instructions preventing commencement of the pre-heating phase of operation unless and until the aerosol-generating article 40 has been inserted into the cavity 22. During the pre-heating phase of operation, the susceptor element 23 is brought to an operational temperature sufficient to evolve vapour from the aerosol-forming substrate. Activation of the pre-heating phase of operation by pressing one of the buttons 381, 382 (or otherwise) results in the lighting control driver 36b operating one or both of outer and inner lighting areas 61, 62 to provide a predetermined light emission visible to the user. This predetermined light emission corresponds to the pre-heating phase of operation. This predetermined light emission may vary with time to indicate progression of the pre-heating phase of operation, thereby providing information to the user of how close the susceptor element 23 temperature is to a predetermined target operating temperature.

On completion of the pre-heating phase of operation, the first housing 20 may be uncoupled from the second housing 30 and the user inhale on the filter 42 of the aerosol-generating article 40 to commence a usage session. The auxiliary controller 26 may include sensors or other detection means to detect a user applied puff such that the device 10 is a puff-on-demand device. On detection of the user applied puff, the auxiliary controller 26 controls the supply of energy from the auxiliary power source 25 to the induction coil 24 according to instructions previously conveyed from the primary controller 36 when the first and second housings 20, 30 were coupled to each other via electrical interface 37. These instructions include a predetermined thermal profile to be followed by the susceptor element 23 over the usage session. Current flow through the induction coil 24 induces heating of the susceptor element 23 according to the predetermined thermal profile. In turn, heating of the susceptor element 23 heats the aerosol-forming substrate 41 of the aerosol-generating article 40 located within the cavity 22, thereby resulting in volatile compounds being evolved from the aerosol-forming substrate 41 in the form of a vapour. In response to each user applied puff, the evolved vapour flows downstream through the aerosol-generating article 40 towards the filter element 42, and cooling to form an aerosol which is inhaled by the user. The usage session continues for a predetermined period of time or a predetermined number of user-applied puffs, after which the supply of energy from the auxiliary power supply 25 to the induction coil 24 ceases and the susceptor element 23 cools down to ambient temperature. For the embodiment described, the auxiliary power supply 35 has an energy capacity sufficient to provide power to the induction coil 24 over the entire duration of a usage session. On completion of the usage session, the aerosol-forming substrate 41 is substantially depleted. The first housing 20 may then be recoupled to the second housing 30 to commence recharging of the auxiliary power supply 25 by the primary power supply 35 via electrical interface 37. At the end of the usage session, the aerosol-generating article 40 is removed from the cavity 22 for disposal.

Although not shown in the figures, in one embodiment a wireless transceiver may be located in each of the first and second housings 20, 30 to allow information on a status of the components of one of the first and second housings 20, 30 to be shared with the respective controller 26, 36 of the other of the first and second housings 20, 30. Such status information may include an indication of the energy level remaining in the auxiliary power source 25, an indication of progression through a given usage session, and the number of puffs applied by a user to the aerosol-generating article 40 over the usage session.

Further, the user may also puff on the aerosol-generating article 40 without decoupling the first and second housings 20, 30 from each other. In this mode of operation, the electrical interface 37 may also serve to allow information on a status of the components of one of the first and second housings 20, 30 to be shared with the respective controller 26, 36 of the other of the first and second housings 20, 30 during a usage session.

One or both of the buttons 381, 382 may be configured to enable selection of a given mode or operational parameter of the aerosol-generating device 10 when the first and second housings 20, 30 are coupled to each other. For the embodiment shown, a double-press of button 381 functions to select a first predetermined thermal profile and a triple-press of button 381 functions to select a second predetermined thermal profile. However, in alternative embodiments (not shown), an alternative user interface may be provided with which a user can interact to select a desired one of the first and second predetermined thermal profiles. Such an alternative user interface may be in the form of a touch sensitive capacitive panel with which a user may engage a finger to select a desired one of the predetermined thermal profiles, the touch sensitive panel coupled to the primary controller 36. The touch sensitive capacitive panel may be integrated into the display window 622 of the inner lighting area 62 and coupled to the primary controller 36. A user may then touch or swipe their finger along the touch sensitive capacitive panel defined by the display window 622 to provide a control input to the device 10. Alternatively, the alternative user interface may include a motion or orientation sensor coupled to the primary controller 36, in which a motion or gesture of the device 10 in a predetermined manner is detected by the sensor and serves as a means of selecting a specific one of the predetermined thermal profiles. The first and second predetermined thermal profiles differ from each other in their intensity, with the second predetermined thermal profile having a greater intensity than the first predetermined thermal profile. The second predetermined thermal profile is associated with supply of a greater amount of energy from the auxiliary power supply 25 to the induction coil 24 over the usage session than for the first predetermined thermal profile.

Although the figures show an aerosol-generating device 10 which employs an inductive heating assembly (in the form of induction coil 24 and susceptor element 23), in other embodiments a resistive heating assembly may instead be employed. Further, in other embodiments, the aerosol-generating device 10 may be formed of a single housing rather than the two-part housing 20, 30 shown in FIGS. 1 to 3.

FIG. 9 illustrates an example of how the lighting control driver 36b controls a supply of electricity from the primary power source 35 to individual ones of the light emitting diodes 611-1 . . . m of the outer lighting area 61 to generate a predetermined light emission indicative of progression through a usage session of the aerosol-generating device 10. At the start of the usage session, the lighting control driver 36b controls a supply of energy from the primary power source 35 to light emitting diodes of the outer lighting area 61 such that the entire annulus of the lighting area 61 is illuminated in the generation of a light emission indicative of the start of the usage session. FIGS. 9(a) to (e) show how, with progression through the usage session, different ones of the light emitting diodes 611-1 . . . m of the outer lighting area 61 are progressively deactivated to reduce the proportion or area of the outer lighting area which is activated. Arrows ‘B’ in FIG. 9(b) show the direction in which different light emitting diodes of the outer lighting area 61 are progressively deactivated over the usage session. The legend in FIG. 9 shows two different static luminance levels for the light emission generated by the light emitting diodes of the outer lighting area 61. These luminance levels are designated as levels 1 and 0. Level 1 represents a maximum luminance level, where level 0 represents a deactivated or “off” state in which no light is emitted. On completion of the usage session, all of the light emitting diodes 611-1 . . . m of the outer lighting area 61 are deactivated so that no light is emitted from the outer lighting area. Over the entire duration of the usage session to which FIG. 9 relates, the lighting control driver 36b maintains the light emitting diodes 621-1 . . . n of the inner lighting area 62 in the deactivated or “off” state.

FIG. 10 illustrates an example of how the lighting control driver 36b controls a supply of electricity from the primary power source 35 to individual ones of the light emitting diodes 621-1 . . . n of the inner lighting area 62 to generate a predetermined light emission indicative of progression through a usage session of the aerosol-generating device 10. At the start of the usage session, the lighting control driver 36b controls the supply of energy from the primary power supply 35 to light emitting diodes of the inner lighting area 62 such that an oval-shaped portion of the lighting area 62 is illuminated in the generation of a light emission indicative of the start of the usage session. FIGS. 10(a) to (e) show how, with progression through the usage session, different ones of the light emitting diodes of the inner lighting area 62 are progressively deactivated to reduce the proportion or area of the inner lighting area which is activated. Arrow ‘C’ in FIG. 10(b) shows the direction in which different light emitting diodes of the inner lighting area 62 are progressively deactivated over the usage session. As for the example of FIG. 9, the legend in FIG. 10 shows two different static luminance levels for the light emission generated by light emitting diodes of the inner lighting area 62. These luminance levels are again designated as levels 1 and 0, with level 1 representing a maximum luminance level and level 0 corresponding to a deactivated or “off” state in which no light is emitted. On completion of the usage session, all of the light emitting diodes of the inner lighting area 62 are deactivated, with no light emitted from the inner lighting area 62. As can be seen, over the entire duration of the usage session to which FIG. 10 relates, the lighting control driver 36b maintains the light emitting diodes of the outer lighting area 61 in the deactivated or “off” state.

FIG. 11 illustrates an example of how the lighting control driver 36b controls a supply of electricity from the primary power source 35 to individual ones of the light emitting diodes 611-1 . . . m of the outer lighting area 61 to generate a predetermined light emission indicative of progression through first and second usage sessions of the aerosol-generating device 10. The second usage session follows the first usage session, using whatever energy remains in the auxiliary power supply 25 after completion of the first usage session. In this example, two distinct portions of the outer lighting area 61 are controlled over the respective first and second usage sessions to generate a light emission which varies according to progress through the respective usage session. As shown in FIG. 11(a), the outer lighting area 61 defines two symmetrically arranged curved segments 61-1, 61-2, each segment extending around 180 degrees of the lighting area. Prior to commencement of the first usage session, the lighting control driver 36b controls the supply of energy from the primary power source 35 to the light emitting diodes 611-1 . . . m of the outer lighting area 61 such that both segments 61-1, 61-2 of the outer lighting area 61 are illuminated over their entire length (see FIG. 11(a)). Illumination of the entirety of both segments 61-1, 61-2 provides a light emission indicative of the auxiliary power source 25 being fully charged and containing sufficient energy to complete two usage sessions. FIGS. 11(a) to (d) show how, with progression through the first usage session, different ones of the light emitting diodes of the outer lighting area 61 are progressively deactivated with progression through the first usage session to reduce the proportion or area of the first segment 61-1 which is illuminated. Arrow ‘E1’ in FIG. 11(b) shows the direction in which different light emitting diodes of the outer lighting area 61 are progressively deactivated over the first usage session to reduce the proportion or area of the first segment 61-1 which is illuminated. The legend in FIG. 11 shows two different static luminance levels for the light emission generated by the light emitting diodes of the outer lighting area 61. These luminance levels are designated as levels 1 and 0. Level 1 represents a maximum luminance level, whereas level 0 represents a deactivated or “off” state in which no light is emitted. On completion of the first usage session, all of the light emitting diodes which contributed to illumination of the first segment 61-1 of the outer lighting area 61 are deactivated, leaving the second segment 61-2 illuminated over its full length. On commencing the second usage session, different ones of the light emitting diodes of the outer lighting area 61 are progressively deactivated with progression through the second usage session to reduce the proportion or length of the second segment 61-2 which is illuminated (see FIGS. 11(d) to (g)). Arrow ‘E2’ in FIG. 11(e) shows the direction in which different light emitting diodes of the outer lighting area 61 are progressively deactivated over the second usage session to reduce the proportion or area of the second segment 61-2 which is illuminated. Over the entire duration of both the first and second usage sessions to which FIG. 11 relates, the lighting control driver 36b maintains the light emitting diodes of the inner lighting area 62 in the deactivated or “off” state.

FIG. 12 illustrates an example of how the lighting control driver 36b controls a supply of electricity from the primary power source 35 to individual ones of the light emitting diodes 611-1 . . . m of the outer lighting area 61 to generate a predetermined light emission indicative of progression through a pre-heating phase of operation of the aerosol-generating device 10. The legend in FIG. 12 shows five different luminance levels for the light emission generated by light emitting diodes of the outer lighting area 61. These luminance levels are designated as levels 4, 3, 2, 1 and 0, in order of decreasing luminance. Level 4 represents a maximum luminance level, whereas level 0 represents a deactivated or “off” state in which no light is emitted. At the start of the pre-heating phase, the lighting control driver 36b controls a supply of energy from the primary power source 35 to the light emitting diodes of the outer lighting area 61 such that the entire thickness of the lighting area 61 is illuminated. FIGS. 12(a) to (d) show how the light emitting diodes of the outer lighting area 61 are controlled by the lighting control driver 36b to deactivate and reduce the luminance level of different light emitting diodes with progression through a first portion of the pre-heating phase, thereby reducing an illuminated thickness t₆₁ and overall luminance of the lighting area 61. FIGS. 12(d) to (g) show how the lighting control driver 36b then progressively reactivates and increases the luminance level of different light emitting diodes of the outer lighting area 61 through a second portion of the pre-heating phase, thereby increasing the illuminated thickness t₆₁ and overall luminance of the lighting area 61. FIGS. 12(a) to (g) represent a single discrete lighting cycle, with the cycle being repeated whilst the aerosol-generating device 10 remains in the pre-heating phase. In other embodiments, the lighting cycle shown in FIG. 12 may be applied to indicate the aerosol-generating device 10 being in a different state to the pre-heating phase; for example, the lighting cycle of FIG. 12 may be applied to where the device 10 is in a pause mode state or a reactivation state.

FIG. 13 illustrates an example of how the lighting control driver 36b controls a supply of electricity from the primary power source 35 to individual ones of the light emitting diodes 611-1 . . . m of the outer lighting area 61 to generate a predetermined light emission indicative of progression through the pre-heating phase of operation of the aerosol-generating device 10. The legend in FIG. 13 shows two different combined colour and luminance states for the light emission generated by the light emitting diodes of the outer lighting area 61 with progression through the pre-heating phase of operation. These combined colour and luminance states are designated as states 1 and 0. State represents a state of maximum luminance having a pink colour, whereas state 0 represents a deactivated or “off” state in which no light is emitted. At the start of the pre-heating phase, none of the light emitting diodes of the outer lighting area 61 are activated. FIGS. 13(a) to (d) show how, with progression through the pre-heating phase, different ones of the light emitting diodes of the outer lighting area 61 are progressively activated to increase a proportion or area of the outer lighting area which is activated to generate the pink coloured light associated with state 1. Arrows ‘F’ in FIG. 13(b) show the direction in which different light emitting diodes of the outer lighting area 61 are progressively activated over the pre-heating phase. On completion of the pre-heating phase, all of the light emitting diodes 611-1 . . . m of the outer lighting area 61 are activated to generate the pink coloured light associated with state 1. Over the entire duration of the pre-heating phase to which FIG. 13 relates, the lighting control driver 36b maintains the light emitting diodes 621-1 . . . n of the inner lighting area 62 in the deactivated or “off” state.

FIG. 14 illustrates an example which is a variation of the example of FIG. 11. As for FIG. 11, the lighting control driver 36b controls a supply of electricity from the primary power source 35 to individual ones of the light emitting diodes 611-1 . . . m of the outer lighting area 61 to generate a predetermined light emission indicative of progression through distinct first and second usage sessions of the aerosol-generating device 10. As shown in FIG. 14(a), the outer lighting area 61 defines two symmetrically arranged segments 61-1, 61-2, each extending around 180 degrees of the lighting area 61. Prior to commencement of the first usage session, the lighting control driver 36b controls the supply of energy from the primary power source 35 to light emitting diodes of the outer lighting area 61 such that both segments 61-1, 61-2 are illuminated over their entire length (see FIG. 14(a)). FIGS. 14(a) to (d) show how, with progression through the first usage session, different ones of the light emitting diodes of the outer lighting area 61 are progressively deactivated with progression through the first usage session to reduce the proportion or area of the first segment 61-1 which is illuminated. Arrow ‘G1’ in FIG. 14(b) shows the direction in which different light emitting diodes of the outer lighting area 61 are progressively deactivated over the first usage session to reduce the proportion or area of the first segment 61-1 which is illuminated. The legend in FIG. 14 shows two different static luminance levels for the light emission generated by the light emitting diodes of the outer lighting area 61. These luminance levels are designated as levels 1 and 0. Level 1 represents a maximum luminance level, whereas level 0 represents a deactivated or “off” state in which no light is emitted. For the duration of the first usage session, the lighting control driver 36b controls different light emitting diodes of the inner lighting area 62 to illuminate two circular regions 62-1, 62-2 of the lighting area 62. Illumination of both circular regions 62-1, 62-2 is indicative of the auxiliary power source 25 containing sufficient energy to complete both the first and second usage sessions. On completion of the first usage session, all of the light emitting diodes which contributed to illumination of the first segment 61-1 of the outer lighting area 61 are deactivated. Also on completion of the first usage session, one of the circular regions 62-1 of the inner lighting area 62 is deactivated, leaving circular region 62-2 illuminated; illumination of this single circular region 62-2 of the inner lighting area 62 is indicative of the auxiliary power source 25 only containing sufficient energy to complete one more usage session, i.e. the second usage session. On commencing the second usage session, different ones of the light emitting diodes of the outer lighting area 61 are progressively deactivated with progression through the second usage session to reduce the proportion or area of the second segment 61-2 which is illuminated (see FIGS. 14(d) to (g)). Arrow ‘G2’ in FIG. 14(e) shows the direction in which different light emitting diodes of the outer lighting area 61 are progressively deactivated over the second usage session to reduce the proportion or area of the second segment 61-2 which is illuminated. On completion of the second usage session, the second segment 61-2 of the outer lighting area 61 is deactivated to be indicative of the second usage session having been completed. In a similar manner, circular region 62-2 of the inner lighting area 62 is also deactivated on completion of the second usage session, thereby providing a visual indication that the auxiliary power source 25 requires recharging or replacing in order for further usage sessions to be undertaken.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number “A” is understood as “A”+10% of “A”. Within this context, a number “A” may be considered to include numerical values that are within general standard error for the measurement of the property that the number “A” modifies. The number “A”, in some instances as used in the appended claims, may deviate by the percentages enumerated above provided that the amount by which “A” deviates does not materially affect the basic and novel characteristic(s) of the claimed invention. Also, all ranges include the maximum and minimum points disclosed and include any intermediate ranges therein, which may or may not be specifically enumerated herein.

1-15. (canceled)

16. An aerosol-generating device for heating an aerosol-forming substrate to generate an inhalable aerosol during a usage session, the aerosol-generating device comprising:
control electronics; and
an annular outer lighting area surrounding an inner lighting area,
wherein the control electronics are coupled to the annular outer lighting area and the inner lighting area and are configured to:
i) selectively illuminate one of the annular outer lighting area and the inner lighting area to generate a first predetermined light emission conveying first data indicative of a state of the aerosol-generating device, and
ii) selectively illuminate the other of the annular outer lighting area and the inner lighting area to generate a second predetermined light emission conveying second data indicative of a state of the aerosol-generating device,
wherein the first data and the second data are different from one another.

17. The aerosol-generating device according to claim 16, wherein the annular outer lighting area and the inner lighting area collectively form a common lighting array.

18. The aerosol-generating device according to claim 16, wherein the inner lighting area comprises a single lighting element.

19. The aerosol-generating device according to claim 18, wherein the single lighting element is centrally positioned in the inner lighting area.

20. The aerosol-generating device according to claim 16, wherein the inner lighting area comprises a group of lighting elements, the group of lighting elements arranged in a circular pattern about a centre of the inner lighting area.

21. The aerosol-generating device according to claim 16, wherein either or both of the annular outer lighting area and inner lighting area is semi-opaque.

22. The aerosol-generating device according to claim 16,
wherein the aerosol-generating device extends longitudinally between first and second ends, and
wherein the annular outer lighting area and inner lighting area are provided on a lateral surface defining one of the first and the second ends.

23. The aerosol-generating device according to claim 16, further comprising a first housing and a second housing.

24. The aerosol-generating device according to claim 23, wherein the first housing is detachably couplable to the second housing.

25. The aerosol-generating device according to claim 23, wherein the first housing defines or comprises a holder for an aerosol-generating article comprising an aerosol-forming substrate.

26. The aerosol-generating device according to claim 23,
wherein the second housing extends longitudinally between first and second ends, and
wherein the annular outer lighting area and inner lighting area are provided on a lateral surface defining one of the first and the second ends.

27. The aerosol-generating device according to claim 23, wherein the second housing comprises one or more of: a power source, control circuitry configured to control a heating arrangement, and one or more buttons accessible from outside of the second housing.

28. The aerosol-generating device according to claim 27, wherein at least one of the one or more buttons is operable to select, activate, change, pause, or deactivate an operating mode of the aerosol-generating device, the one or more buttons being coupled to the control electronics such that the first predetermined light emission or the second predetermined light emission is indicative of the operating mode that is selected, activated, changed, paused, or deactivated by operation of the one or more buttons.

29. The aerosol-generating device according to claim 28, wherein the one or more buttons consist of a first button and a second button.

30. The aerosol-generating device according to claim 16, wherein at least one of the first data and the second data is indicative of any one of:
a) the aerosol-generating device having been activated by a user,
b) selection, activation, changing, pausing, deactivating, or progression of an operating mode of the aerosol-generating device,
c) an energy level of a power source of the aerosol-generating device,
d) a power source of the aerosol-generating device containing sufficient energy to complete a single usage session,
e) a power source of the aerosol-generating device containing sufficient energy to complete two or more usage sessions,
f) a power source of the aerosol-generating device containing a level of energy below a predetermined threshold level of energy,
g) selection or activation of one of a first predetermined thermal profile and a second predetermined thermal profile, in which each of the first predetermined thermal profile and the second predetermined thermal profile define a heating profile for heating of the aerosol-forming substrate by an electrical heating arrangement over the usage session, the first predetermined thermal profile and the second predetermined thermal profile being different from each other,
h) the aerosol-generating device being in one of a pause mode state or a reactivation state,
i) selection or activation of a change in operational state of the aerosol-generating device,
j) progression through the usage session, and
k) progression through a pre-heating phase in which an electrical heating arrangement is heated to a predetermined target temperature.
